(19) United States
(12) Patent Application Publication
(10) Pub. No.: US 2009/0116051 A1
(43) Pub. Date: May 7, 2009

(54) Multifunction Printer and Method for Displaying Warning of Multifunction Printer

(75) Inventor: Eiji KASAI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/262,808

(22) Filed: Oct. 31, 2008

(30) Foreign Application Priority Data
Nov. 6, 2007 (JP) 2007-288246

(51) Int. Cl. G06F 3/12

(52) U.S. Cl. 358/1.13

(57) ABSTRACT

A multifunction printer has a plurality of functions and is configured to perform one of the functions selected as a selected function by a user. The multifunction printer includes a warning display section, a selector and an operation status manager. The warning display section is configured to display warning information of an operation status of each of the functions. The selector is configured to be operated by the user so as to select one of the functions as the selected function. The operation status manager is configured to manage the operation status of each of the functions. The operation status manager is configured to display the warning information on the warning display section caused by the operation status of the selected function only.

### BACKGROUND

1. Technical Field

The present invention relates to a multifunction printer having a plurality of functions and a method for displaying a warning of the multifunction printer.

2. Related Art

A multifunction printer having a plurality of functions such as photocopying, scanning, facsimile, printing and so on may perform a function selected by a user if the user selects the function that the user wants to perform. That is, the multifunction printer is an all-in-one electronic device (becoming popular) that may perform a plurality of different functions.

In a case where, e.g., one of the plural functions causes an error, an alert or a warning (hereinafter, simply called “warning”), however, the multifunction printer usually displays information of the warning (hereinafter, simply called “warning display”) regardless of whether the function causing the warning is a currently selected one (selected function) or not (non-selected function). Thus, the user may select and perform a desired function after canceling the warning display. Hence, a user who is not familiar with operation of the multifunction printer may hesitate to use the printer because of the warning display, or it may be difficult for such a user to cancel the warning display. Even if canceled once, the warning display usually appears again after a while as long as the cause of the warning display is not dealt with. The warning may possibly be displayed to the same user in a repetitive manner, and the user is forced to cancel the warning display each time.

JP A-2007-21827 is an example of related art.

### SUMMARY

An advantage of some aspects of the invention is that a multifunction printer having a plurality of functions may easily perform a function causing no warning.

A multifunction printer of the invention may at least partially solve the above problem as described with respect to following embodiments or applications.

### First Application

According to a first aspect of the invention, a multifunction printer has a plurality of functions and is configured to perform one of the functions selected as a selected function by a user. The multifunction printer includes a warning display section, a selector and an operation status manager. The warning display section is configured to display warning information of an operation status of each of the functions. The selector is configured to be operated by the user so as to select one of the functions as the selected function The operation status manager is configured to manage the operation status of each of the functions. The operation status manager is configured to display the warning information on the warning display section caused by the operation status of the selected function only.

According to the first aspect of the invention, the multifunction printer may display the warning information caused by the operation status of the selected function only selected by the user. If the operation status of the selected function causes no warning, the multifunction printer does not display the warning information on the warning display section. Thus, the user need not remove the display of the warning information as usual, and may immediately perform the selected function causing no warning. Hence, the user may easily perform the function causing no warning.

### Second Application

According to a second aspect of the invention, the multifunction printer according to the first aspect of the invention further includes a warning notifier for each of the functions. The warning notifier is configured to visually notify whether the warning information is present apart from the display of the warning information on the warning display section. The operation status manager is configured, in a case where a non-selected function that is not selected by the user causes the warning information, to make the warning notifier for the non-selected function causing the warning information notify the user of the warning information.

According to the second aspect of the invention, the user may easily know if the non-selected function that is not selected by the user is causing the warning information.

### Third Application

According to a third aspect of the invention, the multifunction printer according to the first aspect of the invention further includes a user management section configured to allow only a plurality of users registered in advance to use the multifunction printer. The user management section is configured to manage an allowable function to be selected by each of the registered users. The operation status manager is configured, in a case where the allowed user selects the allowable function that the allowed user is allowed to use by the user management section as the selected function, to display on the warning display section the warning information of an operation status of the allowable function only selected as the selected function.

According to the third aspect of the invention, the multifunction printer may display the warning information of an operation status of the allowable function only that the user allowed to use the multifunction printer is allowed to use.

The invention is not limited to the invention of the devices described above, and may be an invention of a method such as a method for displaying warning information of a multifunction printer.

### BRIEF DESCRIPTION OF THE DRAWINGS

FIG. 1 is a block diagram of main portions of a multifunction printer of a first embodiment of the invention.

FIG. 2 is an explanatory diagram to show an operation screen SP1 displayed on a display 110 of an operation panel 100 through a display controller 210.

FIG. 3 is another explanatory diagram to show the operation screen SP1 displayed on the display 110 of the operation panel 100 through the display controller 210.

FIG. 4 is yet another explanatory diagram to show the operation screen SP1 displayed on the display 110 of the operation panel 100 through the display controller 210.

FIG. 5 is a block diagram of main portions of a multifunction printer of a second embodiment of the invention.

FIG. 6 is an explanatory diagram to show a case where a forbidden function select button is displayed in such a way as not to be selected.

FIG. 7 is an explanatory diagram to show function select buttons MB1-MB3 formed by hardware keys.

### DESCRIPTION OF EXEMPLARY EMBODIMENTS

Embodiments of the invention will be described on the basis of exemplary applications in the following paragraphs:
A. first embodiment;
A1. configuration of multifunction printer;
A2. warning display operation;
B. second embodiment; and
C. modifications.

### A. First Embodiment

### A1. Configuration of Multifunction Printer

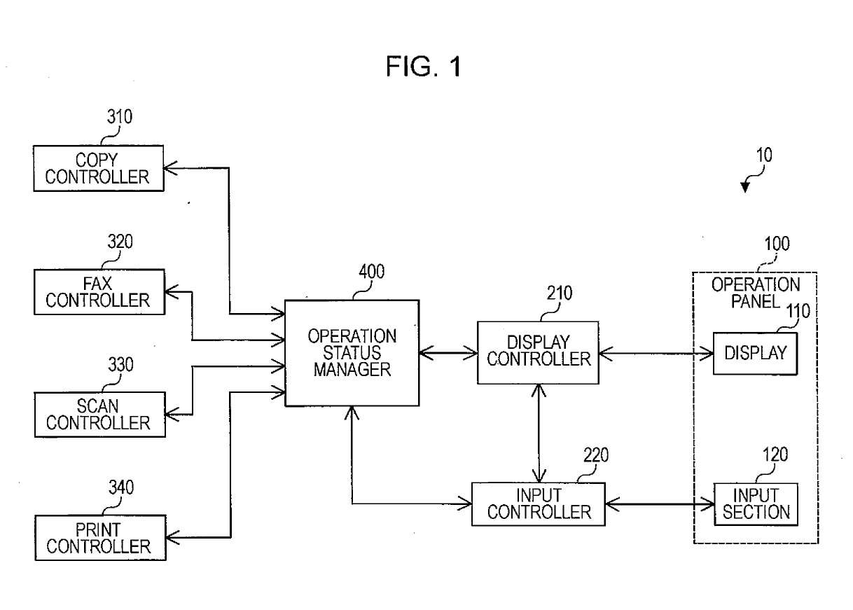

FIG. 1 is a block diagram of main portions of a multifunction printer 10 of a first embodiment of the invention. FIG. 1 only shows blocks relating to warning displays of a plurality of functions that the multifunction printer 10 may perform, and unnecessary blocks are not shown in FIG. 1.

The multifunction printer 10 has an operation panel 100 including a display 110 and an input section 120, a display controller 210 configured to control a display function of the display 110, an input controller 220 configured to control inputs from the input section 120, a copy controller 310 configured to control a copy function, a FAX controller 320 configured to control a FAX function, a scan controller 330 configured to control a scan function, a print controller 340 configured to control a print function, and an operation status manager 400 configured to manage and control operations of each of the above controllers.

The display controller 210 may display an operation screen on the display 110 of the operation panel 100. The input section 120 of the operation panel 100 may obtain input information through various operation buttons displayed on the operation screen. The input section 120 is formed by, e.g., a touch panel provided on the operation screen. Although the input section 120 may have other various operation buttons, their explanations are omitted. The input information obtained by the input section 120 is input to the operation status manager 400 through the input controller 220. The operation status manager 400 may control operation of the functional blocks according to the input information, and in particular may control a warning display on the operation screen displayed on the display 110 in a manner specific to the invention.

### A2. Warning Display Operation

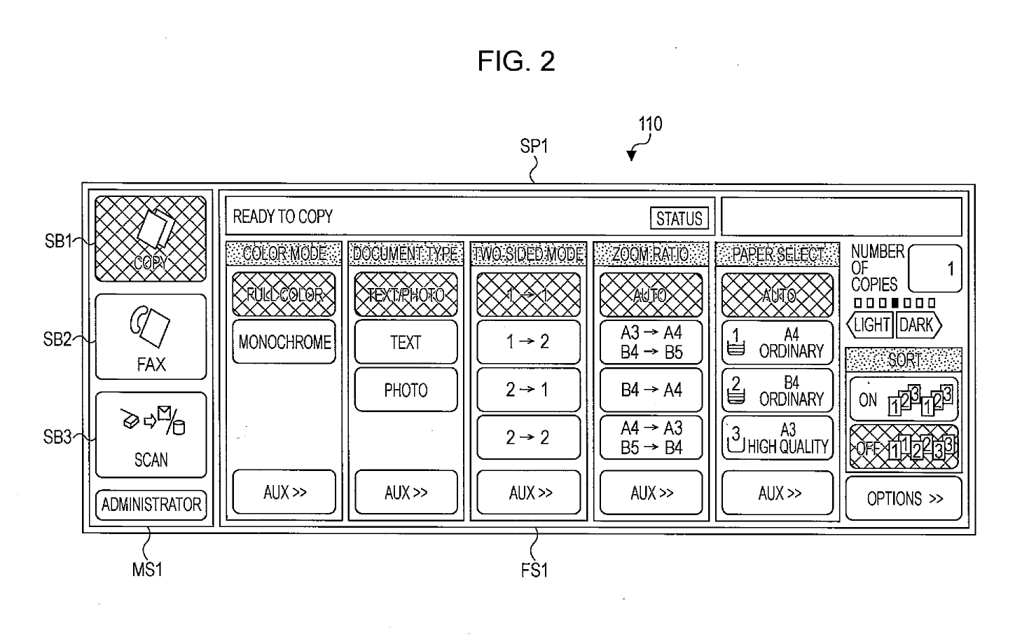

FIGS. 2-4 are explanatory diagrams to show an operation screen SP1 that the display controller 210 displays on the display 110 under control of the operation status manager 400.

The operation screen SP1 is displayed by the display controller 210 on the display 110 according to a control operation sent from the operation status manager 400.

As shown in FIG. 2, the operation screen SP1 is divided into a function menu screen MS1 and an operation condition menu screen FS1.

The function menu screen MS1 corresponds to a selector.

As shown in FIG. 2, the function menu screen MS1 has software keys including a copy function select button SB1, a FAX function select button SB2, and a scan function select button SB3 for each of the above functions. As the print function may not be directly selected by a user but may be selected if a print job is assigned to the multifunction printer 10 through a wired or wireless and local or network connection, the operation condition menu screen FS1 has no print function select button.

The copy function select button SB1, the FAX function select button SB2, and the scan function select button SB3 correspond to a warning notifier.

If the user presses one of the displayed function select buttons SB1-SB3 of the function that the user wants to perform, the function of the pressed button is selected and an associated menu screen is displayed on the operation condition menu screen FS1. For example, in FIG. 2, the copy function is selected after the copy function select button SB1 is pressed. The selected function select button is displayed in reverse, e.g., the background of the button is in black and the letters of the button are in white. In FIG. 2, though, the selected button is shown in a simplified manner with cross hatching.

In the operation condition menu screen FS1 shown in FIG. 2, a screen for selecting operation conditions of the function selected by the function select button (selected function) is shown. As shown in FIG. 2, as the copy function is selected, a screen for selecting operation conditions of a color mode, a document type, a two-sided mode, a zoom ratio, paper selection, the number of copies, contrast and sorting is displayed. Each of the above operation conditions may be selected and set after a condition select button of the condition to be selected is pressed. The condition select button is displayed in reverse after being selected and set in the same manner as the function select button.

Although not shown, an operation condition menu screen of each of the other functions may be displayed according to operation conditions.

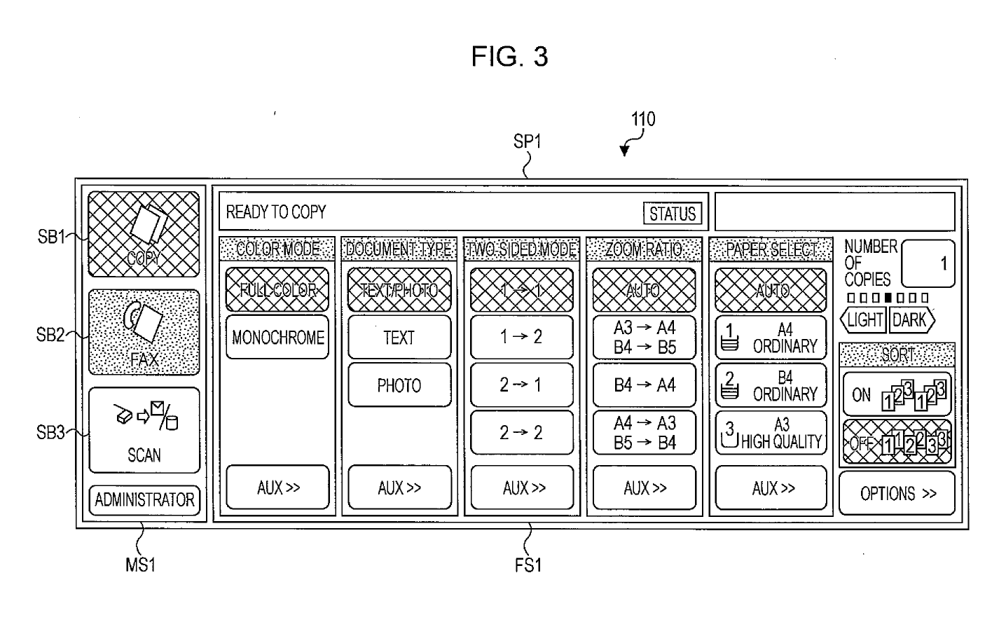

The operation status manager 400 may obtain information on the operation status of the copy, FAX, scan and print functions that the copy controller 310, the FAX controller 320, the scan controller 330 and the print controller 340 may control, respectively, from the above controllers, and may manage each of the above controllers. If one of the functions causes a warning including an error or an alert, the function select button of the function causing the warning is displayed differently from the state of being selected in such a way that, e.g., the background is in yellow to call attention and the letters are in white. As shown in FIG. 3, e.g., the FAX function causes a warning and the display of the FAX function select button SB2 is changed. In FIG. 3, though, the function select button of the function causing the warning is shown in a simplified manner with dot hatching.

Hence, if pressing the copy function select button SB1 and selecting the copy function causing no warning, the user may ordinarily perform the copy function by selecting and setting desired operation conditions on the operation condition menu screen of the copy function displayed in the operation condition menu screen FS1 of the operation screen SP1.

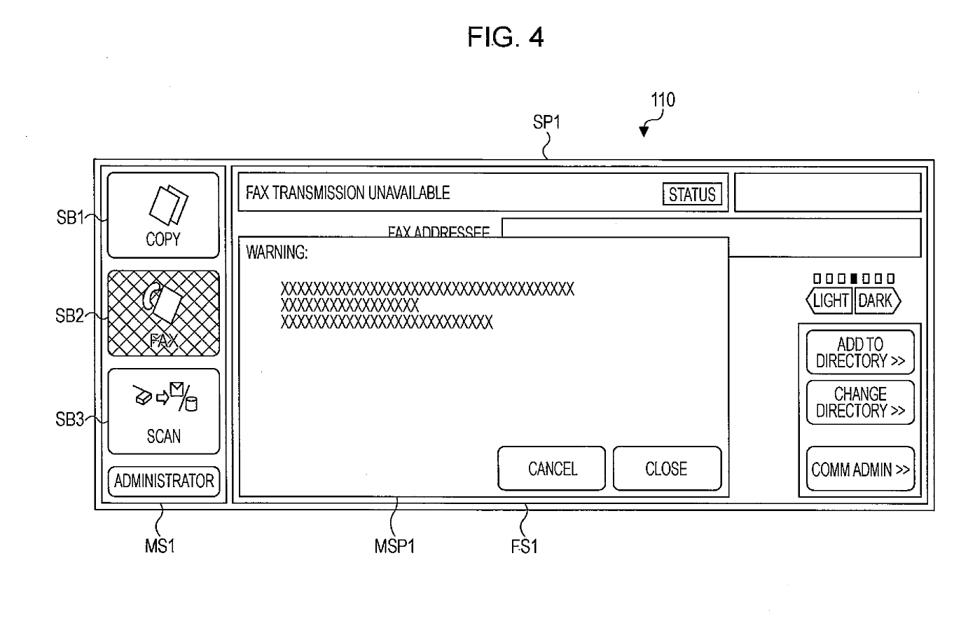

Meanwhile, if the user presses the FAX function select button SB2 of the function causing a warning, the operation condition menu screen of the FAX function is displayed as usual in the operation condition menu screen FS1 of the operation screen SP1 as in the above case where the copy function select button SB1 is pressed. In this case, however, the FAX function causes the warning and the display controller 210 is notified of the warning caused by the FAX function. Thus, having obtained information of the warning from the operation status manager 400, the display controller 210 displays a message screen MSP1 that indicates details of the warning on top of the operation condition menu screen FS1 as shown in FIG. 4.

The message screen MSP1 corresponds to a warning display section.

Each of the functions will be described in detail by being divided into processing functions. The copy function is performed by a scan processing function and a print processing function. The FAX function is performed by the scan processing function and a communication processing function in a transmission case, and by the communication processing function and the print processing function in a reception case. The scan function is performed by the scan processing function and by a file processing function or the communication processing function. Thus, if a warning occurs in the scan processing function, e.g., the warning occurs in all of the copy, FAX and print functions. The function select button of each of the functions is displayed in such a way as to call attention as described above. If one of the function select buttons is pressed, the warning caused by the selected function is displayed accordingly.

If one of the functions causing no warning is selected, the multifunction printer of the first embodiment described above may perform the selected function without displaying warning information that indicates details of the warning caused by any of the other functions. Thus, the user of the multifunction printer need not cancel the warning display that is unrelated to the function that the user will use, and may select and perform the desired function.

The multifunction printer of the first embodiment may visually inform a user of a warning by changing the display of the function select button so as to call attention, if the user wants to use one of the functions causing the warning. The user may deal with the warning displayed after pressing the function select button without being bothered thereby.

### B. Second Embodiment

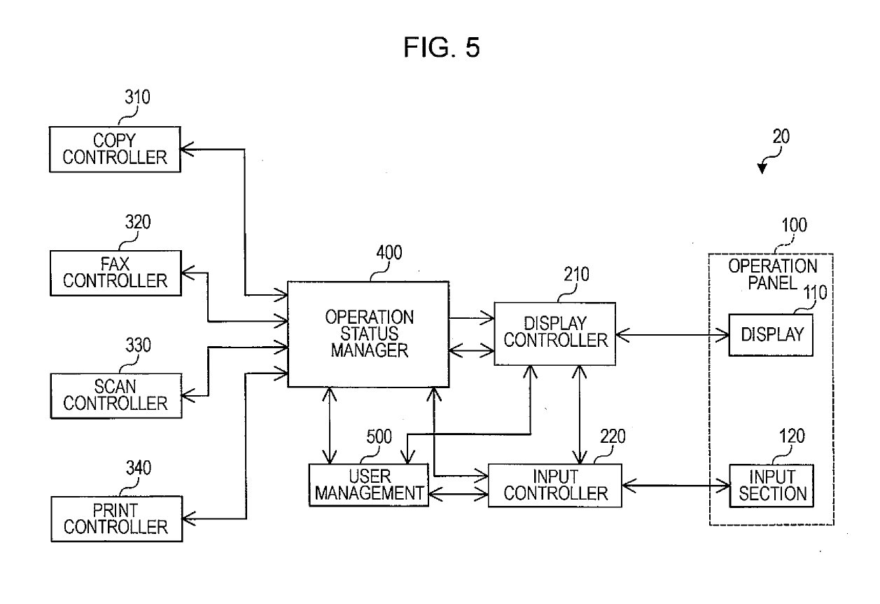

FIG. 5 is a block diagram of main portions of a multifunction printer 20 of a second embodiment of the invention. The multifunction printer 20 has a user management section 500 in addition to the portions of the multifunction printer 10 of the first embodiment.

The user management section 500 may register a user in advance so as to allow registered users only to use the multifunction printer 20, and may manage operation of the multifunction printer 20 on the basis of user registration information. More specifically, after the user enters own identification information and a password assigned to the user, the user management section 500 may perform an authentication process on the basis of the user registration information. The user management section 500 may allow the authenticated users only to use the multifunction printer 20, and may forbid non-authenticated users from using the multifunction printer 20. Warning operation for the users allowed to use the multifunction printer 20 is a same as the operation of the first embodiment.

Each of the users allowed to use the multifunction printer 20 need not be allowed to use all of the plural functions of the multifunction printer 20. The user management section 500 may set allowed or forbidden functions for each of the users. The multifunction printer 20 may provide the authenticated user with the allowed function as the multifunction printer of the first embodiment does. With regard to the forbidden function that may not be selected, meanwhile, the display controller 210 forbids the related function select button to be selected and displays the button accordingly.

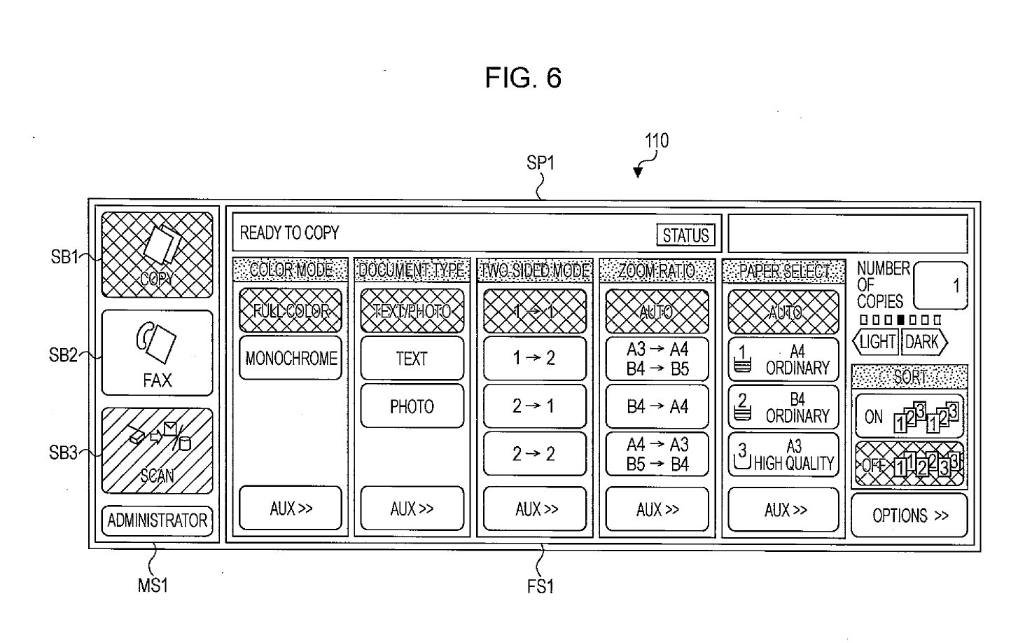

FIG. 6 is an explanatory diagram in which the forbidden function select button is displayed in such a way as not to be selected. In FIG. 6, the scan function select button is displayed in such a way as not to be selected. As shown in FIG. 6, e.g., the not-to-be selected state is shown by diagonal hatching of the background to represent a middle color such as gray.

If one of the functions causing no warning is selected, the multifunction printer of the second embodiment may perform the selected function without displaying warning information that indicates details of the warning caused by any of the other functions, as the multifunction printer of the first embodiment does. Thus, the user of the multifunction printer need not cancel or remove the warning display as usual that has nothing to do with the function that the user will use, and may select and perform the desired function.

The multifunction printer of the second embodiment may visually inform a user of a warning by changing the display of the function select button so as to call attention, if the user will use the function causing the warning. The user may deal with the warning displayed after pressing the function select button without being confused thereby.

As a forbidden function will never be selected, a warning caused by that function, if any, will never be displayed.

### C. Modifications

The invention is not limited to the examples or embodiments described above, and may be variously modified within a scope of the invention.

The multifunction printer of the above embodiments may inform the user of a warning occurrence by changing the displayed color of the function select button. The multifunction printer of the invention is not limited to the above, and may inform the user of the warning occurrence by any ways such as a color change, a pattern change or a shape change as long as the user may be visually aware of the warning occurrence.

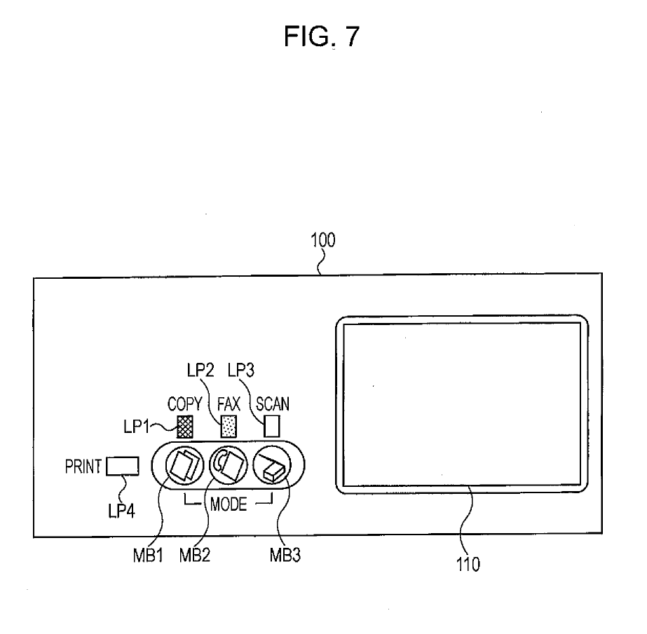

The multifunction printer of the above embodiments uses software keys displayed in the function menu screen MS1 of the display 110. The multifunction printer of the invention is not limited to the above, and may use function select buttons MB1-MB3 formed by hardware keys as shown in FIG. 7. In this case, the multifunction printer has a copy function indicator LP1, a FAX function indicator LP2, a scan function indicator LP3 and a print function indicator LP4 for each of the functions, so as to inform the user of a warning occurrence by changing how to light these indicators depending on whether a warning is present. An indicator of an ordinarily selected function, e.g., may be lit to be “green” as the copy function indicator LP1 related to the copy function shown in FIG. 7 (LP1 is indicated in FIG. 7 with cross hatching representing the green light). An indicator of a function causing a warning may be lit to be “yellow” as the FAX function indicator LP2 related to the FAX function shown in FIG. 7 (LP2 is indicated in FIG. 7 with dot hatching representing the yellow light). The way of lighting the indicators is not limited to the above examples and any way of lighting may be employed as long as the user may be visually aware of a difference among selected or unselected states where no warning is present and a state where a warning is present. Warning information of the selected function may be displayed in the display 110.

Although the above modification has the indicators LP1-LP3 in addition to the function select buttons MB1-MB3, the function select buttons MB1-MB3 may have lighting functions inside the function select buttons MB1-MB3 and may change states of lighting.

Although displaying a warning only if an authenticated user selects an allowed function causing the warning as described with regard to the second embodiment, the multifunction printer may display a warning caused by a function allowed to but not selected by the user.

Although including the user management section 500 inside the multifunction printer as described with regard to the second embodiment, the multifunction printer is not limited to the above and may be connected to a computer that may work as the user management section.

The entire disclosure of Japanese Patent Application No. 2007-288246, filed Nov. 6, 2007 is expressly incorporated by reference herein.

What is claimed is:

1. A multifunction printer having a plurality of functions, the multifunction printer configured to perform one of the functions selected as a selected function by a user, comprising:
a warning display section configured to display warning information of an operation status of each of the functions;
a selector configured to be operated by the user so as to select one of the functions as the selected function; and
an operation status manager configured to manage the operation status of each of the functions, the operation status manager configured to display the warning information on the warning display section caused by the operation status of the selected function only.

2. The multifunction printer according to claim 1, further comprising a warning notifier for each of the functions, the warning notifier configured to visually notify whether the warning information is present apart from the display of the warning information on the warning display section, wherein,
the operation status manager is configured, in a case where a non-selected function that is not selected by the user causes the warning information, to make the warning notifier for the non-selected function causing the warning information notify the user of the warning information.

3. The multifunction printer according to claim 1, further comprising a user management section configured to allow only a plurality of users registered in advance to use the multifunction printer, wherein,
the user management section is configured to manage an allowable function to be selected by each of the registered users, and
the operation status manager is configured, in a case where the allowed user selects the allowable function that the allowed user is allowed to use by the user management section as the selected function, to display on the warning display section the warning information of an operation status of the allowable function only selected as the selected function.

4. A method for displaying warning information of a multifunction printer configured to perform a selected function selected by a user from a plurality of functions, the warning information concerning an operation status of each of the functions, comprising:
managing the operation status of each of the functions; and displaying the warning information of a selected function only selected by the user if the user selects the selected function from among the functions.
